(19) United States
(12) Patent Application Publication
(10) Pub. No.: US 2012/0222884 A1
(43) Pub. Date: Sep. 6, 2012

(54) INSULATED WIRE

(75) Inventors: Yuki HONDA, Hitachi (JP); Tomiya Abe, Hitachi (JP); Shuta Nabeshima, Hitachi (JP); Hideyuki Kikuchi, Hitachi (JP)

(73) Assignee: Hitachi Cable, Ltd.

(21) Appl. No.: 13/410,317

(22) Filed: Mar. 2, 2012

(30) Foreign Application Priority Data
Mar. 2, 2011 (JP) 2011-044986

(51) Int. Cl. H01B 3/44

(52) U.S. Cl. 174/120 SR

(57) ABSTRACT

It is an objective of the present invention to provide an insulated wire having partial discharge resistance comparable to or higher than those of conventional insulated wires even in unstable operating environments. There is provided an insulated wire including: a wire conductor; a first insulation coating formed around the wire conductor, the first insulation coating including inorganic fine particles dispersed therein; and a second insulation coating formed between the first insulation coating and the wire conductor, a relative dielectric constant of the second insulation coating being lower than that of the first insulation coating.

### CLAIM OF PRIORITY

The present application claims priority from Japanese patent application serial no. 2011-044986 filed on Mar. 2, 2011, the content of which is hereby incorporated by reference into this application.

### BACKGROUND OF THE INVENTION

1. Field of the Invention

The present invention relates to insulated wires in which a wire conductor is covered with an insulation coating formed by applying an insulation varnish around the conductor and curing the varnish, and particularly to insulated wires suitable for coils in electrical apparatuses such as motors and transformers.

2. Description of Related Art

Insulated wires (so-called enameled wires) are widely used for coils in electrical equipment such as motors and transformers. Insulated wires for coils are typically formed by applying one or more insulation coatings on a metal conductor having a desired cross section (such as circular and generally rectangular) depending on the shape and application of the coil. Insulation coatings are often formed by applying an insulation varnish on a metal conductor and curing it. Such insulation varnishes are usually prepared by dissolving a resin (such as polyimides, polyamide-imides and polyester-imides) in an organic solvent.

Because of the recent demand for compact, high output power and high efficiency electrical equipment, there has been an increasing use of inverters and high voltages. Voltage surges from inverters and/or the use of high voltages may degrade or damage insulation of coils in electrical apparatuses.

For example, if electric field concentration is present at a small space in a coil (such as a space between adjacent wire turns or a space between a wire turn and a ground (such as the core of the coil), a partial discharge may occur. Partial discharges degrade an insulation coating and in the worst scenario cause dielectric breakdown.

Methods for enhancing the life of an insulation coating against partial discharges includes: suppressing the occurrence of partial discharges (such as increasing the partial discharge inception voltage of the insulation coating); and improving the partial discharge resistance (resistance to coating degradation due to partial discharge). It is known that the partial discharge inception voltage of an insulation coating is proportional to the coating thickness and inversely proportional to the dielectric constant (relative permittivity) of the coating. It is also known that insulation coatings including inorganic fine particles dispersed therein have an improved partial discharge resistance.

For example, JP-B 3496636 discloses a partial discharge resistant enameled wire formed by applying a specific insulation varnish on a wire conductor either directly or indirectly through an intervening insulation coating and curing the varnish. The specific insulation varnish is prepared by mixing an enamel varnish and a transparent or opalescent colloidal solution prepared by dispersing sol particles of metal oxide and/or silicon oxide (average particle size: 100 nm or less) in a dispersion medium compatible with the enamel varnish, in which the parts by weight ratio of the sol particles to the resin component of the enamel varnish is from 3/100 to 100/100. According to JP-B 3496636, the sol particles are uniformly dispersed in the resulting enamel coating, and as a result, the resulting enameled wire has both high partial discharge resistance and high flexibility.

JP-A 2009-161683 discloses an insulated wire formed by applying a specific polyamide-imide resin insulation varnish on a wire conductor either directly or indirectly through an intervening insulation coating and curing the varnish. The specific polyamide-imide resin insulation varnish is prepared by dissolving a polyamide-imide resin in a polar solvent, in which the polyamide-imide resin contains no halogens in the molecular chain but contains, in its monomer unit, an aromatic diisocyanate constituent having three or more benzene rings or an aromatic diamine constituent having three or more benzene rings; and a ratio M/N of the molecular weight (M) of the repeating unit of the polyamide-imide resin to the average total number (N) of the amide groups and imide groups in the repeating unit is 200 or more. The insulation coating of JP-A 2009-161683 has a lower dielectric constant and thus a higher partial discharge inception voltage than those of conventional polyamide-imide resin insulation coatings while maintaining high thermal resistance, good mechanical properties and high oil resistance comparable to those of conventional insulation coatings.

JP-A 2006-299204 discloses a partial discharge resistant insulated wire formed by applying a specific insulation varnish on a wire conductor and curing the varnish. The specific insulation varnish is prepared by mixing a varnish having a polyamide-imide resin dissolved in a solvent including γ-butyrolactone as the main solvent and an organo-silica sol having silica sol particles dispersed in a dispersion medium including γ-butyrolactone as the main dispersion medium, in which percentage of the total amount of the γ-butyrolactone in the total amount of the solvent and dispersion medium is from 50 to 100%; and the parts by weight ratio of the silica sol particles to the polyamide-imide resin is from 1 to 100. According to JP-A 2006-299204, the silica sol particles are uniformly dispersed in the resulting insulation coating, and as a result, the resulting insulation coating has high partial discharge resistance.

### SUMMARY OF THE INVENTION

The recent demand for higher output power and higher efficiency electrical equipment has been accelerating. However, conventional insulation coatings sometimes cannot sufficiently meet such severe requirements (in particular, higher partial discharge resistance). In addition, as electrical apparatuses have had wider applications, they have been sometimes used in harsher operating environments (such as unstable operating environments). As a result, electrical apparatuses sometimes undergo many more partial discharges because of undesirable instabilities in the operating environments (such as temporarily higher ambient pressure or humidity). For example, if the ambient humidity around the insulated wire of a coil increases temporarily, liquid water deposits may occur at some locations in the coil, thereby greatly increasing the relative dielectric constant of the locations of water deposition because the relative dielectric constant of liquid water is comparatively very high (approximately 81). Such increase in dielectric constant will result in increased occurrence of partial discharges. Accordingly, there is a strong need to suppress the occurrence of partial discharges in insulated wires and also a need to increase the life of insulated wires against partial discharges.

In view of the above requirements, it is an objective of the present invention to provide an insulated wire having partial discharge resistance comparable to or higher than those of conventional insulated wires even in unstable operating environments.

According to one aspect of the present invention, there is provided an insulated wire including: a wire conductor; a first insulation coating formed around the wire conductor, the first insulation coating including inorganic fine particles dispersed therein; and a second insulation coating formed between the first insulation coating and the wire conductor, a relative dielectric constant of the second insulation coating being lower than that of the first insulation coating.

In the above aspect of the present invention, the following modifications and changes can be made.

(i) The first insulation coating is formed directly on the second insulation coating without any intervening coating therebetween.

(ii) The second insulation coating is formed by application and curing of a polyamide-imide resin insulation varnish that is prepared by a chemical reaction of a resin component and an isocyanate component where the resin component is synthesized by a chemical reaction of, in a presence of an azeotropic solvent, an acid component and a diamine component including at least one divalent aromatic diamine having three or more aromatic rings.

(iii) The first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

(iv) The matrix resin varnish is made from a polyamide-imide resin.

(v) The isocyanate component, in a molecular thereof, includes a diisocyanate constituent having a flexuous flexible structure.

(vi) The diisocyanate constituent is 2,4′-diphenylmethane diisocyanate.

### ADVANTAGES OF THE INVENTION

According to the present invention, it is possible to provide an insulated wire having partial discharge resistance comparable to or higher than those of conventional insulated wires even in unstable operating environments.

### BRIEF DESCRIPTION OF THE DRAWINGS

FIG. 1 is a schematic illustration showing a cross sectional view of an example of an insulated wire according to the present invention.

### DETAILED DESCRIPTION OF THE PREFERRED EMBODIMENTS

Preferred embodiments of the invention will be described below. The invention is not limited to the specific embodiments described below, but various modifications and combinations are possible without departing from the spirit and scope of the invention.

[Insulated Wire]

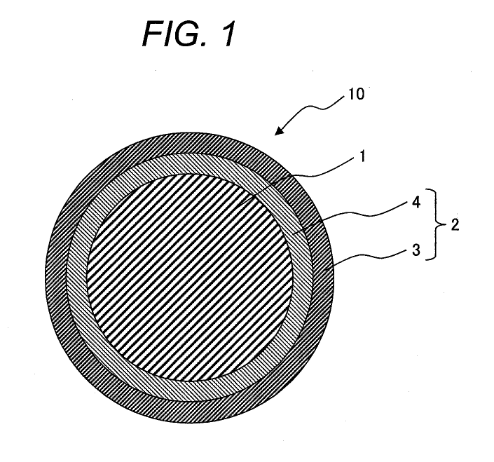

FIG. 1 is a schematic illustration showing a cross sectional view of an example of an insulated wire according to the invention. As shown in FIG. 1, the invented insulated wire 10 includes a wire conductor 1 and a multilayer insulation coating 2 formed on the wire conductor 1. The multilayer insulation coating 2 includes: a first insulation coating 3 having inorganic fine particles dispersed therein; and a second insulation coating 4 provided between the conductor 1 and the first coating 3 and having a relative dielectric constant less than the first insulation coating 3.

The present inventors have intensively investigated the influence of insulation coating structure on the partial discharge inception voltage and the coating degradation due to partial discharge, and have found the following:

a) When a partial discharge occurs at a point of an insulation coating, the radially outer region of the coating point is first degraded by the discharge.

b) Even a low dielectric constant insulation coating is degraded by partial discharge.

c) An insulation coating containing inorganic particles has high partial discharge resistance (i.e., has high resistance to the coating degradation due to partial discharge) even though the inorganic particles have a dielectric constant greater than the matrix material of the coating.

These findings have led to the above-mentioned invented multilayer insulation coating 2 including: the first insulation coating 3 having inorganic particles dispersed therein; and the second insulation coating 4 disposed inner than the coating 3 and having a relative dielectric constant less than the coating 3. The second insulation coating 4 has the effect of increasing the partial discharge inception voltage of the insulated wire 10. And, the first insulation coating 3 has the effect of increasing the partial discharge resistance of the wire 10 (i.e., the effect of suppressing the degradation of the wire 10 even when the wire 10 is exposed to a voltage higher than its partial discharge inception voltage and undergoes partial discharges), thus leading to longer service life.

In addition, the invented structure in which the first insulation coating is formed directly on the second insulation coating has a higher partial discharge resistance (or a longer life against dielectric breakdown caused by partial discharges) than any other structure in which one or more intervening coatings are provided between the first and second insulation coatings.

A thickness of the multilayer insulation coating 2 is preferably 0.1 mm or less in order to increase the filling factor in coils and reduce coil sizes. A thickness ratio (t2/t1) of the thickness (t2) of the second insulation coating 4 to the thickness (t1) of the first insulation coating 3 is preferably from 10/90 to 90/10. Thickness ratios t2/t1 less than 10/90 are not preferable because the resulting wire gains only an insufficient increase in the partial discharge inception voltage and therefore tends to easily suffer from partial discharges. Thickness ratios t1/t2 less than 10/90 (i.e., thickness ratios t2/t1 more than 90/10) are also not preferable because the effect of increasing the partial discharge resistance is insufficient.

There is no particular limitation on a material of the wire conductor 1, but any conventional conductor material that can be enameled (such as copper, aluminum, gold, silver and super conductors) can be used. Conductors plated with a metal such as nickel can also be used. There is also no particular limitation on a shape of the wire conductor 1, but any shape such as round and generally rectangular can be used. The term “generally rectangle”, as used herein, includes squares and rectangles with one or more rounded corners (rounded rectangles).

In the invented insulated wire 10, an adhesion enhancing coating and/or a flexibility enhancing coating may be interposed between the conductor 1 and the second insulation coating 4. Also, a lubrication coating and/or a scratch resistant coating may be disposed on the first insulation coating 3. These optional coatings may be formed by application and curing of an insulation varnish or by extrusion coating.

(First Insulation Coating)

As described above, the first insulation coating includes inorganic particles dispersed therein in order to increase the partial discharge resistance of the resulting insulated wire. More specifically, the partial discharge resistant varnish used to form the first insulation coating is prepared by mixing a matrix resin varnish (a solution of a polyamide-imide resin in a solvent) and an organosol (a dispersion of colloidal particles of metal oxide or silicon oxide in an organic dispersion medium).

In the partial discharge resistant varnish, a parts by mass ratio of the metal oxide (or silicon oxide) particles to the polyamide-imide resin is preferably from 10/100 to 90/100, and more preferably from 10/100 to 25/100. When the inorganic particles coalesce in the matrix resin varnish, the viscosity and/or thixotropy of the varnish increases. Therefore, it is important to uniformly disperse the inorganic particles in the matrix resin varnish. In order to obtain a uniform dispersion, the invention employs an organosol having inorganic particles (as the colloidal particles) dispersed in an organic dispersion medium.

There is no particular limitation on the inorganic particles to be dispersed so long as the particles have good dispersion properties and can enhance the partial discharge resistance of the resulting coating. For example, fine particles of alumina, zirconia, titania, yttria or silica can be used. Use of hydrophobic fine particles (such as hydrophobic silica particles and hydrophobic titania particles) as the inorganic particles is particularly preferable because of the good compatibility with the matrix resin varnish. The average particle size of the colloidal particles in the organosol is preferably 100 nm or less. When hydrophobic fine particles are used, the average particle size is preferably 30 nm or less. Examples of the organic dispersion medium are methanol, dimethylacetamide, methyl ethyl isobutyl ketone, mixtures of xylene and butanol, gamma butyrolactone and cyclohexanone.

Any conventional polyamide-imide resin varnish can be used as the matrix resin varnish. Preferable are polyamide-imide resin varnishes formed by a chemical reaction of a resin component (X) and an isocyanate component (Y) where the resin component (X) is synthesized by a chemical reaction of, in the presence an azeotropic solvent, an acid component and an aromatic diamine component including at least one divalent aromatic diamine having three or more aromatic rings.

(Second Insulation Coating)

As described, the second insulation coating of the present invention has a relative dielectric constant lower than the first insulation coating. The second insulation coating is formed, for example, by application and curing of a polyamide-imide resin insulation varnish that is prepared by a chemical reaction of a resin component (X) and an isocyanate component (Y). The resin component (X) is formed by a chemical reaction of, in the presence of an azeotropic solvent, an acid component and a diamine component including at least one divalent aromatic diamine having three or more aromatic rings. There is no particular limitation on a mixing ratio of the resin component (X) and the isocyanate component (Y) so long as the polyamide-imide resin insulation varnish can be efficiently obtained. The resin component (X) and the isocyanate component (Y) will be described more specifically below.

(Synthesis of Resin Component X)

As mentioned above, the resin component (X) is synthesized by a chemical reaction of a diamine component and an acid component in the presence of an azeotropic solvent.

(Diamine Component)

The diamine component used to obtain the resin component (X) includes at least one aromatic diamine having a divalent aromatic group (R) having three or more aromatic rings. Examples of aromatic diamines having a divalent aromatic group (R) containing three or more aromatic rings include: 2,2-bis[4-(4-aminophenoxy)phenyl]propane (BAPP); bis[4-(4-aminophenoxy)phenyl]sulfone, bis[4-(4-aminophenoxy)phenyl]ether, 9,9-bis-(4-aminophenyl)fluorene, 4,4-bis(4-aminophenoxy)biphenyl, 1,4-bis(4-aminophenoxy) benzene; and isomers of these compounds. Note that the divalent aromatic group (R) having three or more aromatic rings is the divalent residue after removal of the two amino groups from any one of the above-cited aromatic diamines. The use of, as the diamine component, such an aromatic diamine having a divalent aromatic group (R) having three or more aromatic rings reduces the total amount of amide groups and imide groups in the resulting polyamide-imide resin, thereby lowering the dielectric constant of the polyamide-imide resin and enhancing the partial discharge inception voltage of the resulting insulated wire.

(Acid Component)

There is no particular limitation on the acid component used to obtain the resin component (X) so long as the acid component can be reacted with the above-described diamine component in the presence of an azeotropic solvent to synthesize the resin component (X). Examples of such acids include aromatic tricarboxylic acid anhydrides and aromatic tetracarboxylic acid dianhydrides. Examples of aromatic tricarboxylic acid anhydrides are trimellitic anhydride (TMA) and benzophenone tricarboxylic acid anhydride. Trimellitic anhydride (TMA) is more preferable because of its low cost.

Examples of aromatic tetracarboxylic acid dianhydrides include: pyromellitic acid dianhydride (PMDA); 3,3′,4,4′-benzophenone tetracarboxylic acid dianhydride (BTDA); 3,3′, 4,4′-diphenylsulfone tetracarboxylic acid dianhydride (DSDA); 4,4′-oxydiphthalic acid dianhydride (ODPA); 3,3′,4,4′-biphenyl tetracarboxylic acid dianhydride; 4,4′-(2,2-hexafluoroisopropylidene)diphthalic dianhydride (6FDA); 2,2-bis[4-(3,4-dicarboxyphenoxy)phenyl]propane dianhydride (BPADA); 3,3″′,4,4″′-p-quaterphenyltetracarboxylic dianhydride; and 3,3″″,4,4″″-p-quinquephenyltetracarboxylic dianhydride. As needed, an alicyclic tetracarboxylic acid dianhydride obtained by hydrogenation of any one of the above aromatic tetracarboxylic acid dianhydrides may be used in combination with any of the above aromatic tetracarboxylic acid dianhydrides.

Preferably, the monomers of the acid component have a high weight-average molecular weight Mw (e.g., 400 or more) in order to achieve a high partial discharge inception voltage for the resulting coating. BPADA or the like is preferable because of its good reactivity as well as the high adhesion and high flexibility of the resulting coating. There is no particular limitation on the mixing ratio of the diamine component and the acid component so long as the resin component (X) can be efficiently obtained.

When at least one aromatic tricarboxylic acid anhydride (A) and at least one aromatic tetracarboxylic acid dianhydride (B) are used in combination, a mixing molar ratio (A/B) of the at least one aromatic tricarboxylic acid anhydride (A) to the at least one aromatic tetracarboxylic acid dianhydride (B) is preferably from 10/90 to 50/50. In order to achieve a still higher partial discharge inception voltage, it is preferable to use at least one aromatic tetracarboxylic acid dianhydride (B) including at least one aromatic tetracarboxylic acid dianhydride (C) having four or more aromatic rings (such as BPADA). In this case, a molar ratio (C/B) of the moles of the at least one aromatic tetracarboxylic acid dianhydride (C) to the total moles of the at least one aromatic tetracarboxylic acid dianhydrides (B) is preferably from 20/100 to 100/100. The higher the ratio C/B is, the higher the partial discharge inception voltage that can be achieved.

(Azeotropic Solvent)

The resin component (X) is preferably synthesized in a typical solvent (such as N-methyl-2-pryrrolidone) in the presence of an azeotropic solvent. The use of the azeotropic solvent is for the purposes of facilitating the removal of water produced by the synthesis in order to enhance the efficiency of the synthesis reaction (such as imidization), and improving the compatibility between the resulting matrix resin varnish and the organosol used when forming the first insulation coating. Examples of azeotropic solvents are xylene, toluene, benzene and ethyl benzene. Xylene is more preferable because it is easier to use and the resin component (X) of the invention is obtained more effectively.

(Isocyanate Component Y)

As described, the polyamide-imide resin varnish used to form the second insulation coating is prepared by a chemical reaction of the resin component (X) and the isocyanate component (Y). Examples of the isocyanate component (Y) include: aromatic diisocyanates (such as 4,4′-diphenylmethanediisocyanate (MDI); 2,2-bis[4-(4-isocyanatephenoxy)phenyl]propane (BIPP); tolylene diisocyanate (TDI); naphthalene diisocyanate; xylylene diisocyanate; biphenyl diisocyanate; diphenylsulfone diisocyanate; and diphenylether diisocyanate), and isomers and polymers of these aromatic diisocyanates. As needed, an aliphatic diisocyanate (such as hexamethylene diisocyanate, isophorone diisocyanate, dicyclohexylmethane diisocyanate, and xylene diisocyanate); an alicyclic diisocyanate formed by hydrogenation of any one of these aliphatic diisocyanates; or an isomer of any one of these aliphatic diisocyanates and alicyclic diisocyanates may be used alone or in combination with any one of the above-cited aromatic diisocyanates.

The isocyanate component (Y) may include a flexible diisocyanate (Y1) having a deformable moiety or structure. The flexible diisocyanate (Y1) preferably has a divalent aromatic group having two aromatic rings because of the compatibility with the resin component (X). Examples of such flexible diisocyanates (Y1) include: 2,4′-diphenylmethane diisocyanate; 3,4′-diphenylmethane diisocyanate; 3,3′-diphenylmethane diisocyanate; 2,2′-diphenylmethane diisocyanate; and 2,4′-diphenylether diisocyanate.

The addition of the flexible diisocyanate (Y1) enhances the flexibility of the resulting second insulation coating. That is, the resulting second insulation coating (and therefore the resulting insulated wire) can more easily deform in response to external stresses (such as tensile and compressive) during coil formation processes. As a result, the resulting second insulation coating can more stably maintain strong adhesion to the wire conductor and the first insulation coating even after coil winding. Thus, peeling of the coating and/or crack formation in the coating can be prevented more effectively, and as a result good partial discharge resistance can be more stably maintained after coil winding. Of the above-exemplified flexible diisocyanates, 2,4′-diphenylmethane diisocyanate is preferable because of the ready commercial availability and the low cost.

(Chemical Reaction of Resin Component X and Isocyanate Component Y)

There is no particular limitation on a method for chemical reaction of the resin component (X) and the isocyanate component (Y) so long as the polyamide-imide resin can be efficiently synthesized. A reaction catalyst (such as amines, imidazoles and imidazolines) may be used so long as it does not impair the stability of synthesis of the polyamide-imide resin varnish. Also, a reaction stopper (such as alcohols) for stopping the synthesis may be used.

The invented insulation coating having the above-described structure has a high partial discharge inception voltage and high partial discharge resistance (i.e., high resistance to coating degradation due to partial discharge), and thus the invented insulated wire has long service life.

### EXAMPLES

The present invention will be described more specifically below by way of examples. However, the invention is not limited to the specific examples below.

(Preparation of Insulation Varnish (A) for First Insulation Coating)

As described, the first insulation coating of the invention is formed from an insulation varnish (A) having high partial discharge resistance (i.e., high resistance to coating degradation due to partial discharge). The insulation varnish (A) was prepared by mixing a general-purpose polyamide-imide resin and an organo-silica sol (dispersion medium: γ-butyrolactone, average silica particle size: 12 nm). The parts by mass ratio of the silica fine particles in the organo-silica sol to the resin in the general-purpose polyamide-imide resin varnish was “20:100”.

(Preparation of Insulation Varnish (B) for Second Insulation Coating)

The low dielectric constant insulation varnish (B) used to form the second insulation coating was prepared as follows: A mass of 446.5 g of 2,2-bis[4-(4-aminophenoxy)phenyl]propane (BAPP) (as the diamine component), 449.2 g of trimellitic anhydride (TMA) (as the acid component), 2515.9 g of N-methyl-2-pryrrolidone (as the main solvent) and 252 g of xylene (as the azeotropic solvent) were charged in a flask with an agitator, a reflux condenser tube, a nitrogen inlet tube and a thermometer. Then, the resin component (X) was synthesized by heating the flask contents at 180° C. for 6 hours while stirring the flask contents at a rate of 180 rpm, flowing nitrogen gas through the flask at a rate of 1 L/min and intermittently exhausting water (produced by the dehydration reaction) and xylene.

After the thus synthesized resin component (X) in the flask was cooled to 90° C., 313.4 g of 4,4′-diphenylmethanediisocyanate (MDI) (as the isocyanate component (Y)) was added into the flask. Then, the flask contents were reacted at 150° C. for 4 hours at a stirring rate of 150 rpm and at a nitrogen gas flow rate of 0.1 L/min. Finally, 88.4 g of benzyl alcohol and 628.9 g of N,N-dimethylformamide were charged into the flask to stop the reaction. The thus prepared insulation varnish (B) had a viscosity of 2000 to 3000 mPa·s as measured on an E-type viscometer.

(Preparation of Insulated Wire of Example 1)

The invented insulated wire of Example 1 having the FIG. 1 structure was fabricated as follows: First, the second insulation coating (0.040 mm thick) was formed on a 0.8 mm diameter copper wire by repeating application and curing of the insulation varnish (B) several times until the desired thickness (0.040 mm) had been obtained. The application and curing method used was a conventional typical one, which was the same for the first and second coatings in all of the herein-described examples (Examples 1 to 3 and Comparative Examples 1 to 3). Then, the first insulation coating (0.040 mm thick) was formed on the second insulation coating by repeating application and curing of the insulation varnish (A). The thickness measurement was carried out by cross sectional observation, which was the same for all of the below examples.

(Preparation of Insulated Wire of Example 2)

The invented insulated wire of Example 2 was fabricated as follows: First, the second insulation coating (0.010 mm thick) was formed on a 0.8 mm diameter copper wire by repeating application and curing of the insulation varnish (B). Then, the first insulation coating (0.070 mm thick) was formed on the second insulation coating by repeating application and curing of the insulation varnish (A).

(Preparation of Insulated Wire of Example 3)

The invented insulated wire of Example 3 was fabricated as follows: First, the second insulation coating (0.070 mm thick) was formed on a 0.8 mm diameter copper wire by repeating application and curing of the insulation varnish (B). Then, the first insulation coating (0.010 mm thick) was formed on the second insulation coating by repeating application and curing of the insulation varnish (A).

(Preparation of Insulated Wire of Comparative Example 1)

The insulated wire of Comparative Example 1 not according to the invention was fabricated by forming a 0.080 mm thick single insulation coating on a 0.8 mm diameter copper wire by repeating application and curing of the insulation varnish (B).

(Preparation of Insulated Wire of Comparative Example 2)

The insulated wire of Comparative Example 2 not according to the invention was fabricated by forming a 0.080 mm thick single insulation coating on a 0.8 mm diameter copper wire by repeating application and curing of the insulation varnish (A).

(Preparation of Insulated Wire of Comparative Example 3)

The insulated wire of Comparative Example 3 not according to the invention was fabricated as follows: First, a 0.040 mm thick insulation coating made from the insulation varnish (A) was formed on a 0.8 mm diameter copper wire by repeating application and curing of the insulation varnish (A). Then, a 0.040 mm thick insulation coating made from the varnish (B) was formed on the insulation coating made from the varnish (A) by repeating application and curing of the insulation varnish (B).

(Test and Evaluation)

Each of the insulated wire examples (Examples 1 to 3 and Comparative Examples 1 to 3) was subjected to the following measurement and tests.

(1) Partial Discharge Inception Voltage Measurement

The partial discharge inception voltage of each insulated wire example was measured as follows: Ten pairs of two 500 mm long wire pieces were cut from each insulated wire example. The two cut wire pieces of each pair were twisted around each other under a tension of 14.7 N (1.5 kgf) in such a manner as to have nine twists along a length of 120 mm at a middle portion of the twisted wire piece pair. The insulation coatings of each twisted wire pair at an end portion (10 mm long) were peeled off using a wire stripper ABISOFIX. Next, the twisted wire pair was dried in a thermostat at 120° C. for 30 min and placed in a desiccator for 18 hours until room temperature was reached. Then, the partial discharge inception voltage of the twisted wire pair was measured using a partial discharge automatic test system. The measurement was conducted at 25° C. and 50% relative humidity. A 50 Hz sinusoidal voltage was applied across the two wire conductors of the twisted wire pair to charge the insulation coatings between the two insulated wires, and the voltage was increased at a rate of 10 to 30 V/s. For each twisted wire pair, the voltage at which a discharge of 10 pC began to occur 50 times per second was measured. This measurement was repeated three times. The partial discharge inception voltage of each twisted wire pair was defined as the average value of the three measurements. And, the partial discharge inception voltage of each example (Examples 1 to 3 and Comparative Examples 1 to 3) was defined as the average value of the ten twisted wire pairs.

(2) Surge Test for Evaluating Partial Discharge Resistance

A twisted wire pair sample was prepared from each example (Examples 1 to 3 and Comparative Examples 1 to 3). Voltages of 1300 V (10 kHz) and 1000 V (10 kHz) were applied across the two wires of the twisted wire pair sample. For each voltage, the time to dielectric breakdown (hereinafter referred to as “breakdown time”) was measured. Twisted wire pair samples having a breakdown time of 1100 hours or longer were marked with “Excellent”, samples having a breakdown time of 1000 hours or longer and shorter than 1100 hours marked with “Passed”, and samples having a breakdown time of shorter than 1000 hours marked with “Failed” in Table 1.

(3) Winding Test for Evaluating Flexibility

The winding (or wrapping) test defined in JIS C3003 was conducted as follows. Each insulated wire example was wound around a bobbin having the same diameter as the diameter of the wire example in such a manner as to form five coils each having five turns. Each coil was observed for the presence or absence of cracks by means of a 50 magnification optical microscope. If all the five coils had no cracks, the insulated wire example was marked with “Wire Diam” in Table 1, but if not, then the insulated wire example was wound around a bobbin having a diameter twice the diameter of the wire example and the same observation was conducted. If any cracks were observed in any one of the five double diameter coils, the insulated wire example was wound around a bobbin having a diameter three times the diameter of the wire example and the same observation was conducted.

(4) Twist Test for Evaluating Adhesion

The twist test defined in JIS C3003 was conducted as follows. A test piece (sufficiently longer than 250 mm) was cut from each insulated wire example. The test piece was straightened by two clamps 250 mm apart. And, the insulation coating of the straightened wire was partially removed in such a manner that two long and narrow insulation coating strips were stripped off from the wire conductor along the entire length the straightened wire. Then, one of the clamps was rotated with the other being fixed. And, the number of turns (one turn is 360°) until the remaining insulation coating started to bulge out (i.e., partially peel off) from the wire conductor was measured.

(5) Heating Test for Evaluating Thermal Resistance

Two 120 mm long test pieces were cut from each insulated wire example (Examples 1 to 3 and Comparative Examples 1 to 3). An end of the insulation coating of each test piece was peeled off from the wire conductor using a wire stripper ABISOFIX, and an electrode was attached to the exposed wire conductor end. The two test pieces were placed on a load tester (K7800 available from Totoku Toryo Co., Ltd.) in such a manner that the two test pieces were crisscrossed over each other and were pressed by a load of 6.9 N (0.7 kgf). Then, a temperature of the crisscrossed test pieces was increased at a rate of 0.1° C./min while applying a voltage across the test pieces. And, the temperature at which a predetermined current began to flow was measured and was determined to be the softening temperature of the insulation coating of the example.

(Test and Evaluation Results)

Table 1 shows the test and evaluation results for Examples 1 to 3 and Comparative Examples 1 to 3.

TABLE 1
Parameters and Test Results of Examples
1 to 3 and Comparative Examples 1 to 3.

| | | | Example 1 | Example 2 | Example 3 |
|---|---|---|---|---|---|
| Coating | Outer | Varnish | A | A | A |
| Structure | Coating | Type | | | |
| | | Thickness | 0.040 mm | 0.070 mm | 0.010 mm |
| | Inner | Varnish | B | B | B |
| | Coating | Type | | | |
| | | Thickness | 0.040 mm | 0.010 mm | 0.070 mm |
| Relative | Outer Coating | | 4.7 | 4.7 | 4.7 |
| Dielectric | (25° C., 50 RH %) | | | | |
| Constant | Inner Coating | | 3.8 | 3.8 | 3.8 |
| | (25° C., 50 RH %) | | | | |
| Partial Discharge Inception Voltage of | | | 1200 V | 1130 V | 1250 V |
| Entire Coating (25° C., 50 RH %) | | | | | |
| Surge | 1300 V | | Passed | Passed | Passed |
| Resistance | 1000 V | | Excellent | Excellent | Excellent |
| Flexibility | Minimum Coil Diameter | | Wire Diam. | Wire Diam. | Wire Diam. |
| Adhesion | Number of Turns | | 87 | 84 | 95 |
| Thermal | Softening Temp. | | 442° C. | 435° C. | 430° C. |
| Resistance | | | | | |
| | | | Comparative | Comparative | Comparative |
| | | | Example 1 | Example 2 | Example 3 |
| Coating | Outer | Varnish | B | A | B |
| Structure | Coating | Type | | | |
| | | Thickness | 0.080 mm | 0.080 mm | 0.010 mm |
| | Inner | Varnish | | | A |
| | Coating | Type | | | |
| | | Thickness | | | 0.070 mm |

| Relative | Outer Coating | 3.8 | 4.7 | 3.8 |
|---|---|---|---|---|
| Dielectric | (25° C., 50 RH %) | | | |
| Constant | Inner Coating | | | 4.7 |
| | (25° C., 50 RH %) | | | |
| Partial Discharge Inception Voltage of | | 1290 V | 1100 V | 1200 V |
| Entire Coating (25° C., 50 RH %) | | | | |
| Surge | 1300 V | Failed | Failed | Failed |
| Resistance | 1000 V | Excellent | Excellent | Excellent |
| Flexibility | Minimum Coil Diameter | Wire Diam. | Wire Diam. | Wire Diam. |
| Adhesion | Number of Turns | 95 | 80 | 87 |
| Thermal | Softening Temp. | 430° C. | 449° C. | 441° C. |
| Resistance | | | | |

As shown in Table 1, each of the invented insulated wires of Examples 1 to 3 did not suffer from dielectric breakdown until after 1000 hours even at 1300 V-which was higher than the partial discharge inception voltage of the insulated wire. Thus, the invented insulated wire has high resistance to partial discharges occurring at voltages higher than the partial discharge inception voltage (e.g., surge voltages from an inverter). In contrast, each of the conventional insulated wires of Comparative Examples 1 to 3 suffered from breakdown in a time shorter than 1000 hours at 1300 V although it did not undergo breakdown until after 1100 hours at 1000 V—which was lower than the partial discharge inception voltage of the insulated wire. Thus, the insulated wires not according to the invention were not sufficiently resistant to partial discharges occurring at voltages higher than the partial discharge inception voltage (e.g., surge voltages from an inverter). The flexibility, adhesion and thermal resistance of the invented insulated wires of Examples 1 to 3 were comparable to those of the conventional insulated wires of Comparative Examples 1 to 3.

It is demonstrated from the above result that the invented insulated wire has high resistance to partial discharges occurring at voltages higher than the partial discharge inception voltage (e.g., surge voltages from an inverter). Hence, the present invention provides electrical apparatuses having long service life even in unstable operating environments (such as temporarily higher ambient pressure or humidity) which may potentially cause many more partial discharges than in stable environments.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulated wire comprising:
a wire conductor;
a first insulation coating formed around the wire conductor, the first insulation coating including inorganic fine particles dispersed therein; and
a second insulation coating formed between the first insulation coating and the wire conductor, a relative dielectric constant of the second insulation coating being lower than that of the first insulation coating.

2. The insulated wire according to claim 1, wherein the first insulation coating is formed directly on the second insulation coating without any intervening coating therebetween.

3. The insulated wire according to claim 1, wherein the second insulation coating is formed by application and curing of a polyamide-imide resin insulation varnish that is prepared by a chemical reaction of a resin component and an isocyanate component where the resin component is synthesized by a chemical reaction of, in a presence of an azeotropic solvent, an acid component and a diamine component including at least one divalent aromatic diamine having three or more aromatic rings.

4. The insulated wire according to claim 2, wherein the second insulation coating is formed by application and curing of a polyamide-imide resin insulation varnish that is prepared by a chemical reaction of a resin component and an isocyanate component where the resin component is synthesized by a chemical reaction of, in a presence of an azeotropic solvent, an acid component and a diamine component including at least one divalent aromatic diamine having three or more aromatic rings.

5. The insulated wire according to claim 3, wherein the isocyanate component, in a molecular thereof, includes a diisocyanate constituent having a flexible structure.

6. The insulated wire according to claim 4, wherein the isocyanate component, in a molecular thereof, includes a diisocyanate constituent having a flexible structure.

7. The insulated wire according to claim 1, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

8. The insulated wire according to claim 2, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

9. The insulated wire according to claim 3, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

10. The insulated wire according to claim 4, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

11. The insulated wire according to claim 5, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

12. The insulated wire according to claim 6, wherein the first insulation coating is formed by application and curing of a partial discharge resistant polyamide-imide resin insulation varnish that is prepared by mixing a matrix resin varnish and an organosol which is a dispersion of colloidal particles of metal oxide or silicon oxide in an organic dispersion medium.

13. The insulated wire according to claim 7, wherein the matrix resin varnish is made from a polyamide-imide resin.

14. The insulated wire according to claim 8, wherein the matrix resin varnish is made from a polyamide-imide resin.

15. The insulated wire according to claim 9, wherein the matrix resin varnish is made from a polyamide-imide resin.

16. The insulated wire according to claim 10, wherein the matrix resin varnish is made from a polyamide-imide resin.

17. The insulated wire according to claim 5, wherein the diisocyanate constituent is 2,4′-diphenylmethane diisocyanate.

18. The insulated wire according to claim 6, wherein the diisocyanate constituent is 2,4′-diphenylmethane diisocyanate.

19. The insulated wire according to claim 11, wherein the diisocyanate constituent is 2,4′-diphenylmethane diisocyanate.

20. The insulated wire according to claim 12, wherein the diisocyanate constituent is 2,4′-diphenylmethane diisocyanate.
